(19) United States
(12) Patent Application Publication
(10) Pub. No.: US 2009/0117471 A1
(43) Pub. Date: May 7, 2009

(54) LITHIUM ION BATTERY ELECTRODE AND METHOD FOR MANUFACTURE OF SAME

(75) Inventors: Clare P. GREY, Stony Brook, NY (US); Hailong Chen, Stony Brook, NY (US)

Correspondence Address: THE FARRELL LAW FIRM, P.C., 290 Broadhollow Road, Suite 210E, Melville, NY, 11747, US

(73) Assignee: The Research Foundation of the State University of New York, Albany, NY (US)

(21) Appl. No.: 12/261,715

(22) Filed: Oct. 30, 2008

Related U.S. Application Data
(60) Provisional application No. 60/983,775, filed on Oct. 30, 2007.

(51) Int. Cl. H01M 4/40

(52) U.S. Cl. 429/231.95

(57) ABSTRACT

Disclosed is a method for synthesizing a lithium transition metal oxide nanostructure for the cathode material LiCoO₂, by using a molten salts/hydroxides flux method, and a device thereof.

### PRIORITY

This application claims priority to U.S. Provisional Application No. 60/983,775, filed Oct. 30, 2007, the contents of which are incorporated herein by reference.

### GOVERNMENT RIGHTS

This invention was made with government support under grant numbers DMR0442181 and DMR0506120 awarded by the National Science Foundation and grant number DE-AC02-05CH11231 awarded by the Department of Energy. The government has certain rights in the invention.

### BACKGROUND OF THE INVENTION

The present invention relates to rechargeable lithium batteries and a method for producing electrodes for same. In particular, the present invention provides an improved method for producing improved nanostructure arrangement of battery cathodes via a low temperature molten salt technique.

Lithium Ion Batteries (LIBs) are popular rechargeable batteries used in portable electronic devices such as cell phones and laptops, due to their long cycle life and high capacity. Components of and a method for crystallizing a cathode material for use in a lithium secondary cell are described in U.S. Pat. No. 5,565,284 to Koga et al. and U.S. Pat. No. 6,376,027 to Lee et al., the contents of each of which are incorporated herein by reference. However, relatively low charge/discharge rates and safety concerns have limited LIB use in applications that require both high power and high capacity, such as electric and hybrid electric vehicles. Limitations on discharge rate result from a number of factors including low ionic (Li⁺) and electronic conductivity of the electrode materials and slow insertion/extraction of Li⁺ into the cathode, at the cathode-electrolyte interface.

In layered cathode materials, both the charge on the transition metal layers and the interlayer spacing are important in reducing the activation energies for Li⁺ ion diffusion, resulting in high rate performances. Various attempts have been made to improve the cathode material. See, Kang, K. et al., Electrodes with high power and high capacity for rechargeable lithium batteries. Science, Vol. 311, February 2006, pp. 977-980. An approach to achieving a high recharge rate involves the synthesis of materials with larger cathode-electrolyte interfaces, for example, via the synthesis of nanoparticles, nanowires, thin films, and porous structures. However, this approach is not always straightforward for oxides, and is often associated with high costs.

Generally, high temperatures are required to achieve phase purity and good crystallinity, while the synthesis of nanostructures and porous structures is typically achieved at much lower temperatures. Furthermore, both the stoichiometry and local structure must be carefully controlled to optimize electrochemical performance. For example, LiCoO₂, the most popular cathode material for lower-power LIBs, is usually made by solid-state reaction at 800-1000° C.

### SUMMARY OF THE INVENTION

The present invention overcomes the shortcomings of the conventional systems by via a molten salt synthesis of LiCoO₂ to create a ‘desert-rose’ formation for use in a high performance cathode.

The present invention provides a method for creation of a molten hydroxide flux method to synthesize lithium transition metal oxides at very low temperatures. In a preferred embodiment, crystalline products are obtained having excellent cation ordering between Li and Co layers. The large flexibility in type and concentration of the anion in the flux allows for improved control of morphology and preferred growth direction, allowing for improved design of materials with controlled morphologies, preferably for secondary battery applications.

### BRIEF DESCRIPTION OF THE DRAWINGS

The above and other objects, features and advantages of certain exemplary embodiments of the present invention will be more apparent from the following detailed description taken in conjunction with the accompanying drawings, in which:

FIG. 1 shows an ex-situ diffraction pattern of molten hydroxide flux as utilized in the present invention;

FIGS. 2a-f are ex-situ Scanning Electron Microscope (SEM) micrographs of the present invention;

FIG. 3 provides an enlarged view of the inset of FIG. 2;

FIG. 4 provides SEM images of LiCoO₂ samples utilized as a cathode material in the present invention;

FIG. 5 provides Transmission Electron Microscope (TEM) images of the LiCoO₂ utilized in the present invention;

FIG. 6 shows discharge capacities as a function of cycle number for the LiCoO₂ utilized in the present invention;

FIGS. 7a-b show electron diffraction patterns of an intermediate product of reactions in molten hydroxide flux of the present invention;

FIG. 8 shows a synchrotron X-ray diffraction pattern and Rietveld refinement of the LiCoO₂ utilized in the present invention, when heated for 48 hours;

FIG. 9 shows Li MAS NMR spectra results for commercial LiCoO₂ and LiCoO₂ extracted according to the method of the present invention after one, four and forty-eight hour heating intervals;

FIG. 10 provides SEM images of LiCoO₂ samples made with various nitrates hydroxide ratios;

FIG. 11 is an SEM image of LiCo_{0.5}Mn_{0.5}O₂ of the present invention;

FIG. 12 is an XRD pattern of LiCo_{0.5}Mn_{0.5}O₂ of the present invention;

FIG. 13 is a graph of capacity versus cycle numbers for LiCo0.5Mn0.5O2 manufactured by the molten salt method; and

FIG. 14 shows improvements in cyclability obtained for desert rose LiCoO₂ by AlF₃ coating of the present invention.

### DETAILED DESCRIPTION OF THE PREFERRED EMBODIMENTS

The following detailed description of preferred embodiments of the invention will be made in reference to the accompanying drawings. In describing the invention, explanation about related functions or constructions known in the art are omitted for the sake of clearness in understanding the concept of the invention, to avoid obscuring the invention with unnecessary detail.

Attempts to synthesize at low temperatures via hydrothermal methods generally results in the growth of particles larger than several micrometers. See, Y. M. Chiang, et al., Nat. Mater, 2002, 1, 123. The growth mechanism of the present invention differs from the mechanism described by V. Pralong, et al., J. Matter. Chem., 1999, 9, 955, and Y. M Chiang, et al., J. Electrochem. Soc., 1998, 145, 887, for the conversion of Co(OH)₂ to CoOOH and LiCoO₂, respectively, for hydrothermal and solid state reaction synthesis. In the present invention, solubility of Co(OH)₂ (and Co³⁺) in the highly basic (and oxidizing) flux allows for a slow dissolution of the Co(OH)₂ phase, oxidation to form Co³⁺ and growth of LiCoO₂ from nuclei on both the original Co(OH)₂ phase, followed by growth on LiCoO₂ rods.

Conventional methods use high temperatures of between 700 and 900° C. to react solid materials in a solid state high-temperature synthesis, or to react solids precipitated out of solution, to provide LIB cathodes. The present invention utilizes a much lower temperature, by using an appropriate, low melting temperature flux system, to provide a nanostructure with good electrochemical performance at high rates. In the present invention, a molten mixed alkali metal hydroxide flux is used as the reaction solvent, with the larger viscosity and dielectric of the eutectic system resulting in particles that can be much finer than those prepared by solid state reactions.

The present invention also provides a method to synthesize a lithium transition metal oxide nanostructure for cathode material LiCoO₂ via a molten salts/hydroxides flux method. A method of the present invention allows low temperature synthesis of particles having an increased active surface area, formed by growth of the connected particles from a central nucleation site or from a central particles, thereby maximizing electrical contact between the particles. This both provides a larger active surface area and an improved rate of cycling, and improved capacity retention, since the particles retain electrical contact over many electrochemical cycles. The present invention provides improved electrochemical performance of a desert rose LiCoO₂ by AlF₃ coating.

A preferred embodiment of the present invention utilizes low concentrations of nitrates or other anions other than OH⁻ to yield desert rose and similar morphologies via a dissolution-oxidation-precipitation mechanism, to provide high rate sustainable electrochemical performance.

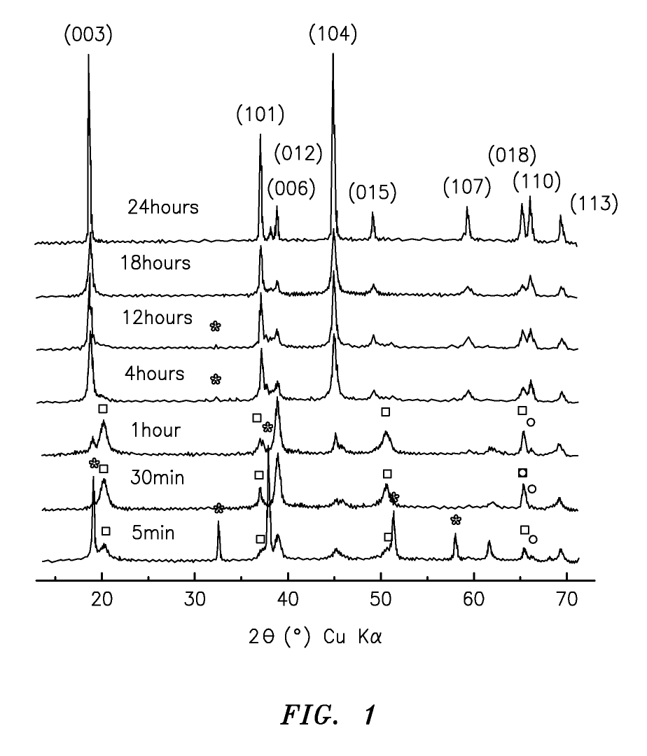

In a preferred embodiment of the present invention, a desert rose form of LiCoO₂ is prepared as follows. Two grams of CsOH.H₂O, six grams of KOH, 1 g of LiOH, and 0.58 grams of Co(NO₃)₂ are put in a Teflon container and heated to 200° C., either statically in a muffle furnace or in a oil bath with vigorous stirring for 5 minutes −48 hours. As shown in the ex-situ diffraction pattern of the molten hydroxide flux of FIGS. 1a-g, the well-ordered, phase-pure LiCoO₂ formed in twelve hours.

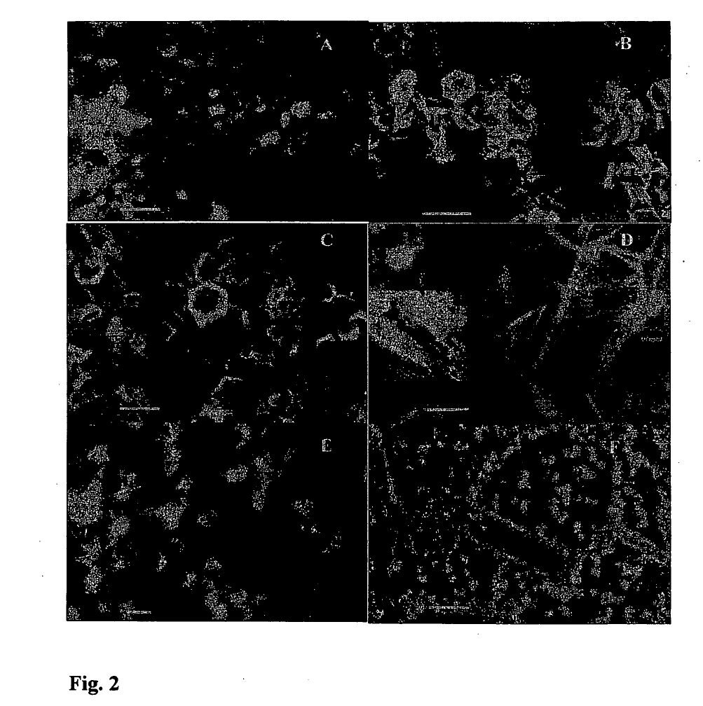

The compound is then air-cooled and dark black, insoluble LiCoO₂ products are separated from the eutectic mixture by washing with of deionized water and filtration. The compound is dried overnight at 80° C. FIGS. 1 and 2 show ex-situ XRD and SEM micrographs obtained from particles extracted as a function of reaction time at 200° C. from the flux comprising a 3:6:1 molar ratio of LiOH, KOH and CsOH.H₂O with a melting point of approx. 180° C. and the precursor Co(NO₃)₂. Based on this data, a series of reactions, as set out in Table 1, is derived.

TABLE 1

| | |
|---|---|
| Co(NO₃)₂ + 4OH⁻ → Co(OH)₄²⁻ + 2NO₃₋ | (1) |
| Co(OH)₄²⁻←→ Co(OH)₂ + 2OH⁻ | (2) |
| 2Co(OH)₂ + 0.5O₂ → 2CoOOH + H₂O | (3) |
| CoOOH + 7H₂O ←→ Co(OH₂)₆³⁺ + 3OH⁻ | (4) |
| Co(OH₂)₆³⁺ + Li⁺ → LiCoO₂ + 4H₂O + 4H⁺ | (5) |

Cobalt (II) oxides and hydroxides are amphoteric and dissolve in basic solutions to form the (blue) Co(OH)₄²⁻ ion, the blue color being clearly visible in the initial washings of the solid product. After 5 minutes (sample A, FIG. 2a), Co(OH)₂ is observed as the major phase, (reaction (2)), and based on the sharp, intense reflections of Co(OH)₂ seen in the XRD pattern, the larger hexagonal-shaped plates in the SEM micrograph of FIG. 2A are also assigned to this phase.

Oxidation of Co²⁺ to Co³⁺ has commenced already and CoOOH is present as the secondary, less-crystalline phase. Some LiCoO₂ forms even after 5 minutes of heating. Most of the Co(OH)₂ phase has been oxidized to CoOOH following 0.5-1 hour of heating (FIGS. 1(b) and 1(c)). A new morphology occurs, the large hexagonal plates, originally due to Co(OH)₂, leaching or dissolving from the center, the edges remaining intact.

Oxidation of the Co(OH)₂ particles (and Li⁺/H⁺ exchange) apparently occurs from the edges of the hexagonal plates, stabilizing the edges of the crystals and slowing down the Co²⁺ dissolution. Exfoliation of the plates is also seen, consistent with ion-exchange between the layers and the layer shearing that is required for the transformation of Co(OH)₂ to CoOOH and LiCoO₂. At the same time, finer (rod-like) crystals of LiCoO₂ begin to nucleate and grow on the faces of the hexagonal plates; a phenomenon more clearly shown in the SEM micrographs of FIG. 2d taken after heating for 4 hours.

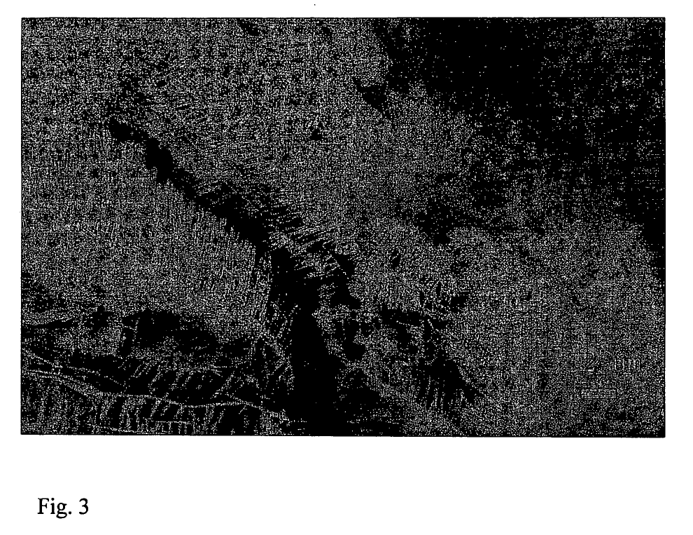

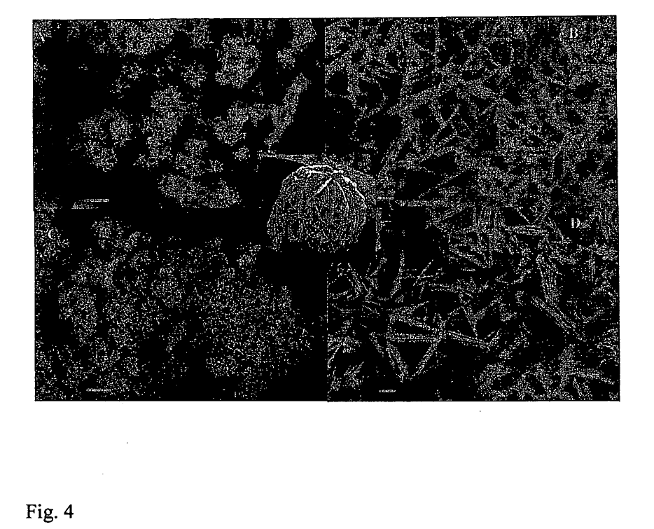

FIG. 3 shows the enlargement of the inset shown in FIG. 2. The morphology is due to hyperbranched growth of LiCoO₂ in the molten hydroxide fluxes. FIG. 4 is an SEM image of LiCoO₂ samples obtained by heating in molten hydroxides for 24 (A,B) and 48 hours at different magnifications, with scale bars provided at 1 μm, 200 nm, 10 μm and 1 μm, respectively, and an inset showing a natural desert rose.

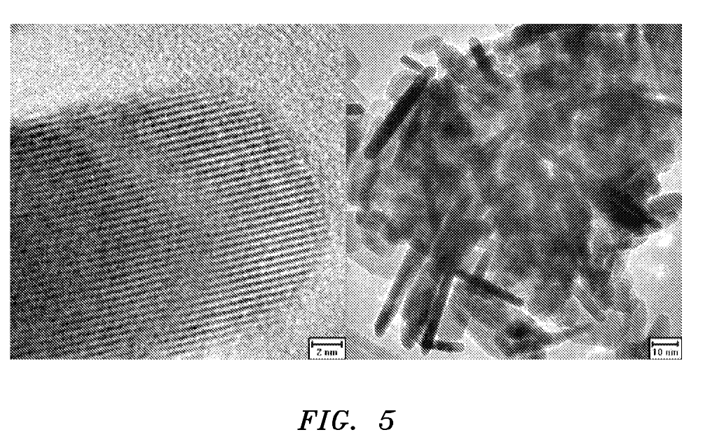

At this stage, CoOOH and Co(OH)₂ are present only as minor phases and the small LiCoO₂ particles act as new nucleation centers for LiCoO₂ growth. The growth directions are more clearly seen following more extended heating, as shown in the inset of FIG. 2d. The morphology of the crystal assembly is similar to the “hyperbranched” growth seen, for example, for PbSe and PbS. PbSe and PbSe adopt crystal structures with cubic symmetry and hence a cubic 3D network is formed. In contrast, the layered material LiCoO₂, tends to form finely spaced plates or rods, the growth occurring on the (001) face, which is perpendicular to the direction labeled “[001]” in FIG. 5. Rods or plates are formed which are dominated the (001) faces as shown in FIG. 5, which shows the desert rose balls after they were sonicated to break up the cathode structure, to view individual plates within the desert rose balls. The (001) planes comprise either the Co or Li layers.

This growth mechanism is readily rationalized because the (001) surface is charged, as it is terminated by either O, Co, or Li. In contrast, growth in a perpendicular direction maintains charge neutrality. The high dielectric constant of these fluxes presumably helps in the termination of non-charge balanced (001) faces that form during growth. Finally, in the fourth stage, between 12 to 24 hours, single phase LiCoO₂ is observed, as shown in FIGS. 1(g), 2(e), all the hexagonal rings have dissolved and the nucleation and growth of the LiCoO₂ smaller particles results in spherical balls of branched, rod-like crystals. This morphology resembles the ‘desert rose’ form of the mineral gypsum, as shown in the inset of FIG. 4.

Larger assemblies of the desert-rose balls are seen in FIG. 2(f), which also illustrates how the larger plate-like Co(OH)₂ crystals, which served originally as nucleation sites, have slowly dissolved away to provide more cobalt for the growing desert-rose structures. The balls grow larger and the thin plates/rods of the ball grow thicker and begin to split into bundles on more extended heating (48 hours), and the crystallinity of the samples increase.

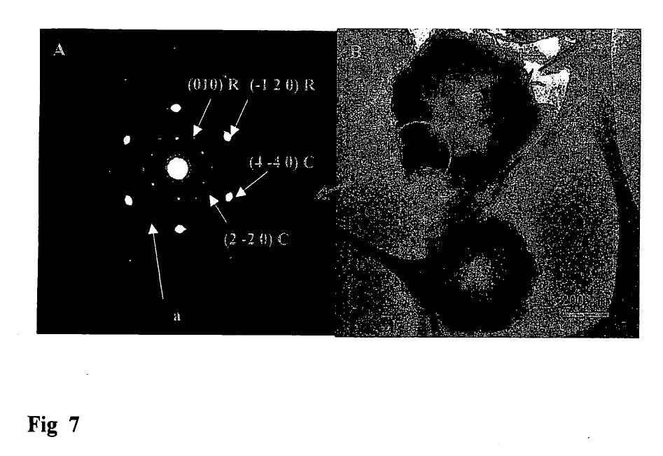

The electron diffraction pattern of the edges is consistent with a mixture or intergrowth of a layered CoOOH phase and a cubic, low-temperature LiCoO₂ phase. As shown in FIG. 7, the electron diffraction pattern of the intermediate product of the reactions in the molten hydroxides flux (A) and the corresponding bright field image (B). Bar in (B) is 200 nm. FIG. 7 corresponds to the electron diffraction pattern of the edge of the hexagonal ring shown in FIG. 2(d) in the main text. Two sets of reflections are present, which are indexed to an intergrowth of a CoOOH phase (viewed along [001] zone axis, indicated as “R” in FIG. 7 since it has a R-3m space group,) and a Li₂₋ₓCO₂O₄ phase (viewed along the [111] zone axis, indicated as “C” since it has a Fm-3m cubic space group). The strongest spots correspond to an overlap of the (−1 2 0) reflections of CoOOH, and (4-4 0) reflections of Li₂₋ₓCO₂O₄. The weak spots indicated by “a” are systematically absent in either LiCO₂O₄ or Li₂CO₂O₄ simulated patterns, however, a small amount of Li—Co exchange will dramatically increase the diffraction intensity of this spot, implying some Li—Co substitutional disorder.

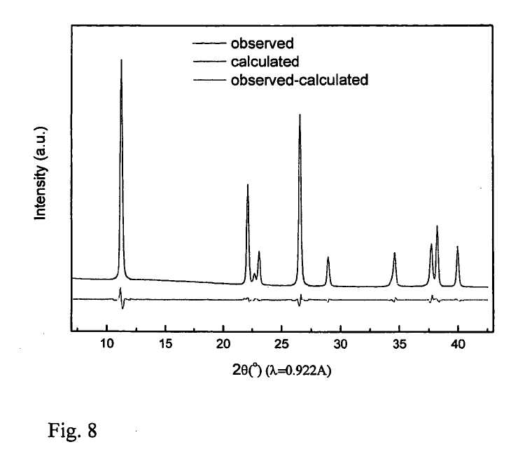

FIG. 8 provides synchrotron X-ray diffraction pattern and Rietveld refinement of the structure of desert-rose LiCoO₂ heated for 48 hours, showing observed patterns, calculated peak positions and the difference of two patterns. No Li/Co interchange was allowed during the refinement, based on the results of ⁷Li MAS NMR spectroscopy. Isotropic strain and shape factors were used since the particles have a large aspect ratio as shown in SEM and TEM pictures, which lead to a better fit. Cell parameters of c=14.0803(3)Å, a=b=2.81818(3)Å, with Rp=1.38%, wRp=2.21% were obtained, being slightly larger than those reported for micrometer-sized LiCoO₂, (typically a=b=2.812-2.816 and c=14.03−14.06 Å), but consistent with cell parameters reported previously for LiCoO₂ nanoparticles.

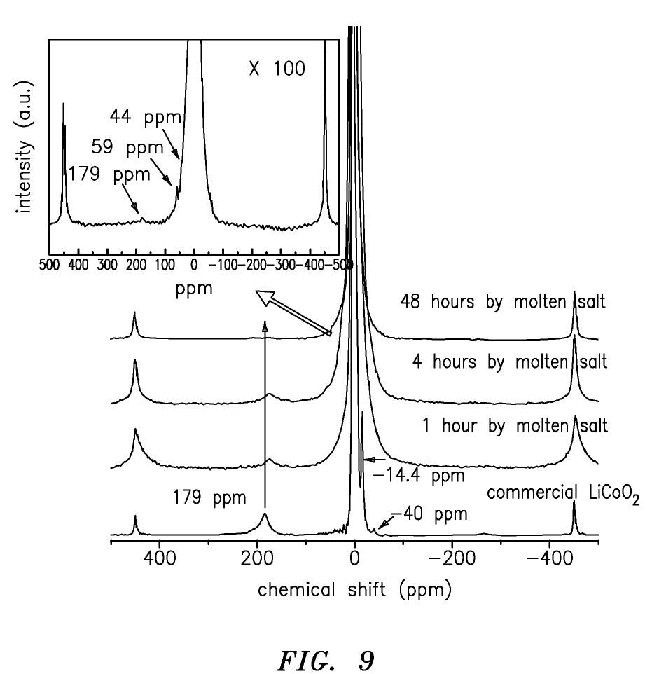

FIG. 9 provides ⁷Li MAS NMR results for commercial LiCoO₂ (Sigma-Aldrich) and products extracted following 1 hour, 4 hours and 48 hours heating in the molten salts system at 200° C. The ⁷Li MAS NMR experiments were performed with a double-resonance 1.8 mm probe, built by Samoson and co-workers, on a CMX-200 spectrometer using a magnetic field of 4.7 T. The spectra were collected at an operating frequency of 29.46 MHz at a spinning frequency of 35 kHz with a rotor-synchronized spin-echo sequence (π/2−τ−π−τ−acq.). π/2 pulses of 3.5 μs were used, with recycle delay times of 0.5 s. All the NMR spectra were referenced to a 1 M ⁷LiCl solution, at 0 ppm. The inset shows a 100-fold enlargement on intensities of the spectrum of the 48 hours sample. The spectra of all the samples are dominated by the signal at 0 ppm due to the stoichiometric regions of sample, where only Co³⁺ (low-spin d⁶) ions are present. The peaks shown in the spectrum of commercial LiCoO₂ at 179, −14.4 and −40 ppm are the typical resonances for Li-excess LiCoO₂. Although present in molten flux samples following 1 and 4 hours of heating, these peaks are not readily seen in the 48-hour desert-rose sample unless the spectrum of this sample is enlarged 100-fold times.

The XRD patterns of the samples were acquired with a bench-top X-ray diffractometer (Rigaku MiniFlex) and by using synchrotron radiation X-Ray diffraction at the Beamline X7B at the National Synchrotron Light Source (NSLS) located at Brookhaven National Laboratory (BNL). Cell parameters of a=b=2.8182, and c=14.0821 Å, (WRP=2.21%) were obtained by Rietveld refinement, which are slightly larger than those reported for micrometer-sized LiCoO₂, (typically a=b=2.812−2.816 and c=14.03−14.06 Å), but consistent with cell parameters reported previously for LiCoO₂ nanoparticles. See, M. Okubo, et al., J. Am. Chem. Soc. 2007, 129, 7444. SEM and TEM were performed by using LEO-1550 field emission and JOEL-4000 high resolution microscopes, respectively. TEM was use to obtain the 2-D lattice image and single crystal electron diffraction patterns of the samples. Energy Dispersive X-Ray (EDX) measurements show only peaks due to Co and O; with Li not observable within the SEM detector window. Electrochemical experiments were performed with LiCoO₂ samples mixed with poly-vinylidene fluoride binder and acetylene black (6:1:3 wt %) in N-methylpyrrolidone to make thick slurry. The slurry was deposited on an aluminum foil by the doctor-blade method and dried at 80° C. overnight. Coin cells (CR2032, Hohsen Corp.) were assembled in an argon-filled glove box. Each cell typically contained 6-8 mg of active material, separated from the Li foil anode by a piece of Celgard separator (Celgard, Inc., U.S.A.). A 1 M solution of LiPF₆ in ethylene carbonate/dimethyl carbonate (1:1) was used as the electrolyte. Galvostatic electrochemical experiments were carried out with an Arbin Instruments (College Station, Tex.) battery cycler at various rates.

Comparison of the relative intensity of the different peaks indicates that the 48 hour molten salt sample is very close to stoichiometric LiCoO₂, and is more stoichiometric and ordered than the commercial sample prepared by a solid state reaction.

The growth mechanism of the present invention differs from conventional methods of Tarascon et al., J. Mater. Chem. 1999, 9, 955 and Chiang et. al., J. Electrochem. Soc. 1998, 145, 887, for the conversion of Co(OH)₂ to CoOOH and LiCoO₂ via hydrothermal and solid state reaction syntheses. The final products of the present invention are preferably derived via a solid state reaction involving the original hexagonal shaped Co(OH)₂ crystals, CoOOH/LiCoO₂ particles with the same shape as a ‘mother’ Co(OH)₂ crystal that is formed. This mechanism is presumably similar to that responsible for the formation of the lithiated hexagonal rings, but is not responsible for the formation of final LiCoO₂ phase.

In the present invention, solubility of Co(OH)₂ (and Co³⁺) in the highly basic (and oxidizing) flux allows for the slow dissolution of the Co(OH)₂ phase, oxidation to form Co³⁺ and the growth of LiCoO₂ from nuclei on both the original Co(OH)₂ phase, and later on, on the LiCoO₂ rods.

Synchrotron radiation X-ray diffraction of the forty-eight hour material indicates that the material is phase-pure. Significant incorporation of K⁺ (or Cs⁺) is excluded since K (or Cs) was not detected by EDX analysis. ⁷Li MAS NMR spectroscopy, which is extremely sensitive to small variations in the stoichiometry of Li_{1±x}CoO₂ materials, also indicates that these materials are more ordered than a typical sample of commercial LiCoO₂ prepared by high temperature route.

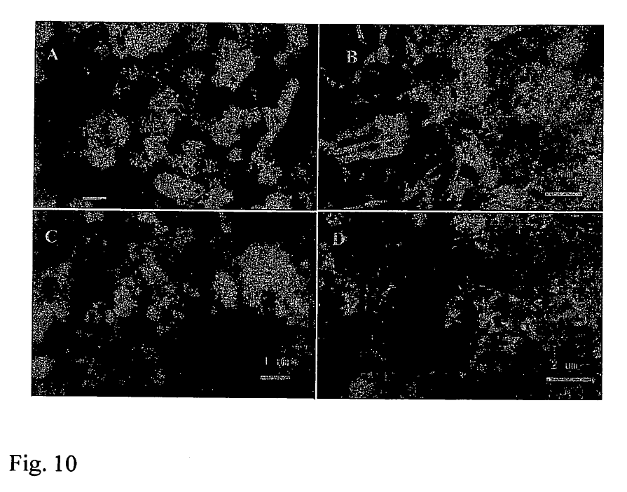

FIG. 10 provides SEM images of LiCoO₂ samples made with various nitrates: hydroxide ratios. The LiNO₃—KNO₃—LiOH—KOH—CsOH eutectic system was used for all the samples with total (NO₃⁻): (OH⁻) ratios of 2:1, (D) 1:1 (C) and 1:4 (B). Co(NO₃)₂ was used as the starting material and the mixtures were heated at 24 hours at 200° C. An image of desert-rose LiCoO₂ ((NO₃⁻):(OH⁻) ratio of 1:75) (A) is shown below for comparison. The scale bars are 1 μm, 5>m, 1 μm and 2 μm, respectively. The results showed that as the concentration of NO₃⁻ increases, the final LiCoO₂ products show less desert rose morphology and less branched growth. More fine, isolated hexagonal plates are observed, is more clearly shown in FIG. 10(d).

TEM of the 24 hour sample confirms that the desert-rose structure is formed from rod-like crystals, with faces (001), as shown in FIG. 5, representing the major surfaces of these rods, and the surfaces of the desert-rose balls being terminated by rounded faces perpendicular to (001) planes. The (003) planes, with d-spacings of 4.68 Å, corresponding to the spacings between the Co layers are clearly observed, parallel to length of the rod. Furthermore, since many of the rods are thin enough to be imaged perpendicular to the direction of the (001) faces, this indicates that the surface perpendicular to this direction is also large. The surfaces perpendicular to the (001) face are electrochemically active for Li⁺ deintercalation/insertion.

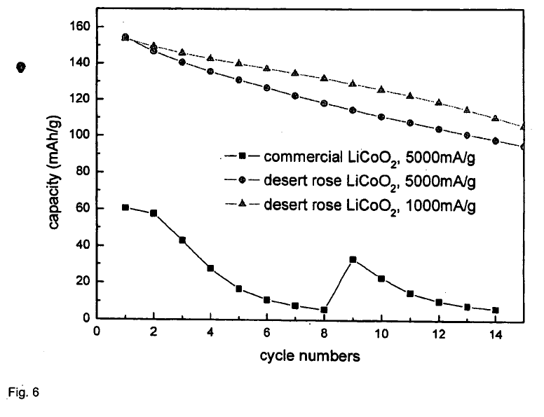

As shown in FIG. 6, electrochemical tests on desert-rose LiCoO₂ and a commercial sample were performed at rates of 1000 and 5000 mAh/g, (7 and 36 C if the practical capacity is assumed to correspond to removal of 50% of Li).

The desert rose LiCoO₂ of the present invention provides a large discharge capacity of 155 mAh/g at a 7 C rate (between 2.54.5V), and the same capacity at 36 C (24.8V). The overpotential during high rate cycling is also much lower than that seen for the commercial micron-sized material. The desert rose morphology of the present invention provides an excellent high rate performance by covering the surfaces of the balls with the Li-insertion active surfaces. This morphology also appears to have an advantage over LiCoO₂ cathode materials, e.g., See, M. Okubo, et al., J. Am. Chem. Soc. 2007, 129, 7444, made up of individual nanoparticles, since the individual particles within the ball are all electrically connected. SEM studies of the cathode materials confirm that the desert rose morphology is maintained after grinding with carbon and pressing to form the battery cell.

In the present invention, the precursor salts and anions have a pronounced affect of the morphology of the final product. For example, increasing the NO₃⁻ concentration in the low temperature molten salt systems results in a progressively less well-developed desert rose morphologies and the formation of finer, isolated hexagonal plates, with much poorer electrochemical performance. The molten flux method of the present invention is not limited to LiCoO₂ and those of skill in the art can also prepare other transition metal lithium oxides utilizing the method described above.

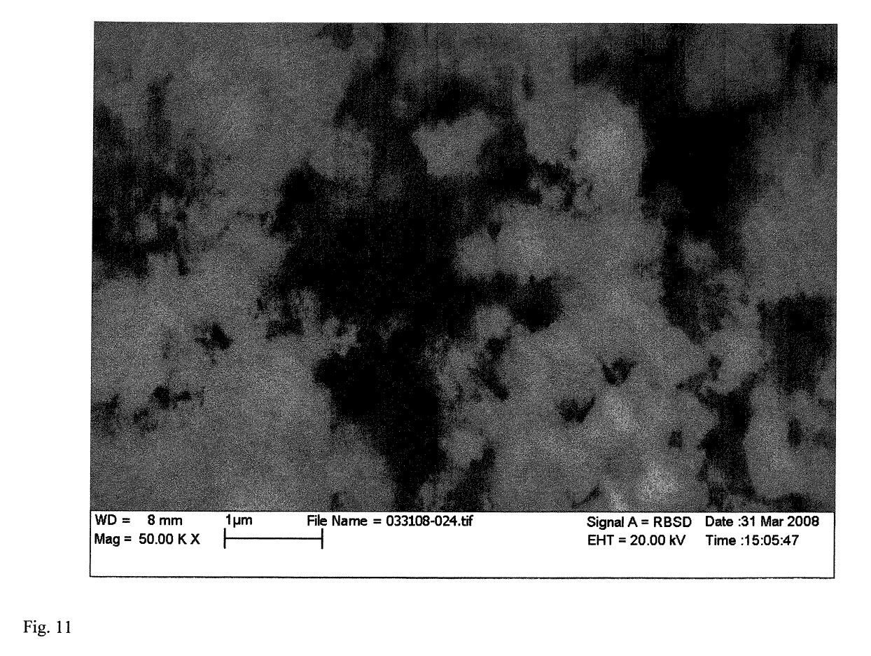

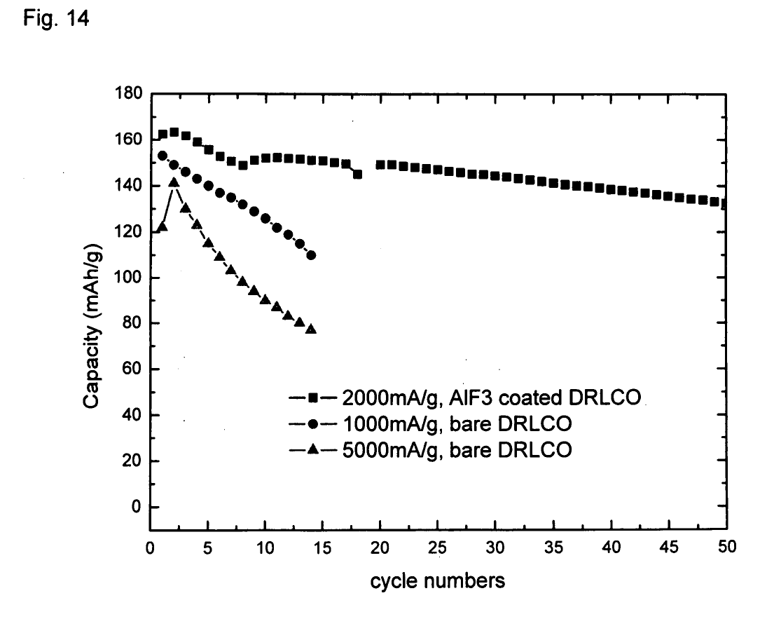

An additional embodiment of the present invention provides a series of cathode materials for lithium ion batteries synthesized by low temperature molten salt method that include LiFe₅O₈, LiMnO₂, LiCoxMn₁₋ₓO₂, LiMn₂O₄., as described in regard to FIGS. 11-14 in regard to data obtained for LiCo₁₋ₓMnₓO₂, wherein x=approx. 0.5.

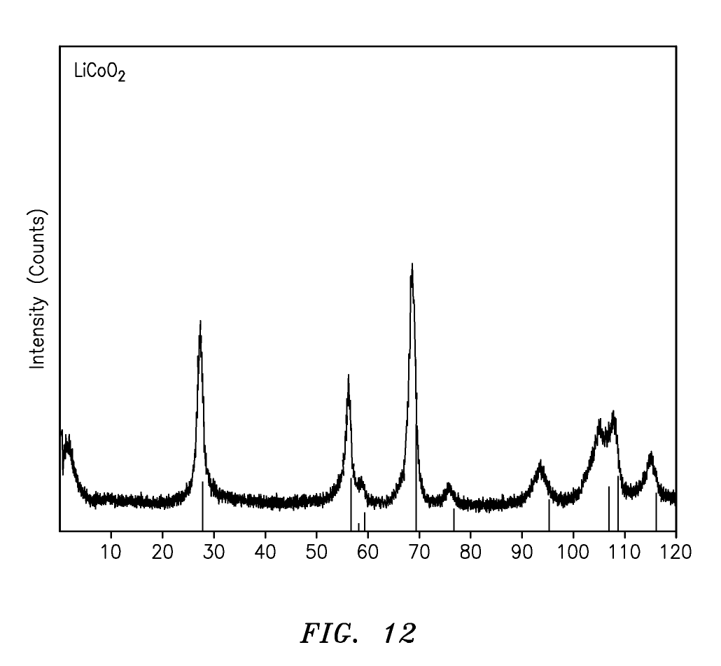

FIG. 11 is an SEM image of LiCu_{0.5}Mn_{0.5}O₂ of the present invention, and FIG. 12 is an XRD pattern of LiCO_{0.5}Mn_{0.5}O₂ of the present invention, with (Cr tube, lambda=2.289A). Compared to the standard pattern of LiCoO₂ (vertical lines), the LiCO_{0.5}Mn_{0.5}O₂ sample shows a perfect layered structure with a slightly different cell parameters from LiCoO₂, having cell parameters (from a refinement using GSAS) of a=b=2.8383, c=14.2605 A, where typical LiCoO2 parameters (JCPDS 50-0653) are a=b=2.8149, c=14.0493 A.

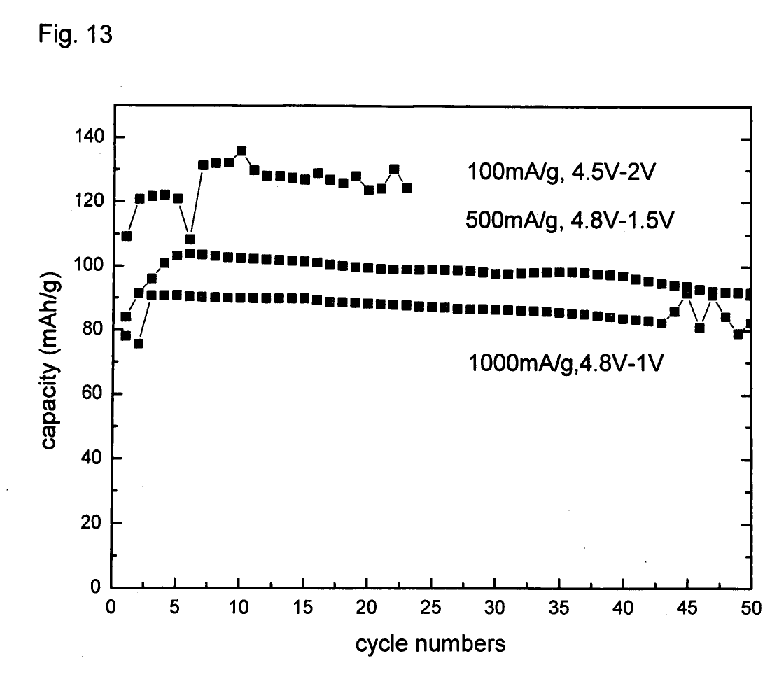

FIG. 13 shows capacity change by cycle numbers for LiCO_{0.5}Mn_{0.5}O₂ manufactured by the molten salt method, as a function of current, showing significant improvement of cyclability of desert rose LiCoO₂ by AlF₃ coating, utilizing the approach described by Y. K. Sun, K. Amine, et al. Electrochemistry Communications 8 (2006) pp. 821-826, in which a thin layer of AlF₃ was coated on the bare cathode material. As an example for LiCoO₂, a solution containing LiCoO₂ powder, Al(NO₃)₃, and NH₄F (Al:F ratio=1:3, Al:Li ratio=0.025:1) is vigorously stirred; and a precipitate forms by reaction of Al(NO₃)₃ and NH₄F on the surface of LiCoO₂. The coating is then annealed at 400° C. for one hour in an inert atmosphere (N₂ or Ar), forming a thin layer on the surface of LiCoO₂, with a thickness and homogeneity of the layer depending on a relative ratio of AlF₃ vs. LiCoO₂ and particle size of bare LiCoO₂.

While the invention has been shown and described with reference to certain exemplary embodiments of the present invention thereof, it will be understood by those skilled in the art that various changes in form and details may be made therein without departing from the spirit and scope of the present invention as defined by the appended claims and equivalents thereof.

What is claimed is:

1. A lithium ion electrode for a rechargeable lithium-ion battery comprising:
an electrode formed of a lithium transition metal oxide having adjacent Li and Co layers, separated by oxygen ions, with Li-insertion active surfaces bisecting the layers,
wherein the Li-insertion active surfaces contain both lithium and cobalt.

2. The electrode of claim 1, further comprising balls having the Li-insertion active surfaces.

3. The electrode of claim 2, wherein the balls are crystalline products.

4. The electrode of claim 1, wherein metal in the cobalt layer is replaced by a transition metal.

5. The electrode of claim 1, wherein metal in the cobalt layer is a replaced by a plurality of different transition metals.

6. The electrode of claim 1, wherein the lithium transition metal oxide is synthesized using a low temperature molten flux.

7. The electrode of claim 5, wherein the lithium transition metal oxide forms a desert rose morphology, comprising a plurality of intergrown, hyper-branched particles.

8. An electrode of a secondary battery having an electrode particle morphology with Li-insertion active surfaces having a desert rose morphology.

9. A method for improved rate performance of electrode materials, the method comprising synthesizing of a transition metal oxide in a low temperature flux, which melts at 200° C. or below.

10. The method of claim 9, wherein the low temperature molten flux includes a mixture of CsOH.H₂O, LiOH and KOH.

11. The method of claim 10, wherein the a mixture further includes NaOH, KNO3, LiNO3, CsNO3.

12. A method for manufacture of LiCoO₂ of use in a cathode of electrode of a secondary battery, the method comprising:
heating a mixture of CsOH.H₂O, KOH, LiOH, and Co(NO₃)₂ at a temperature of 180-200° C.;
cooling the mixture;
obtaining from the mixture, by washing with water and filtration, insoluble products; and
drying the mixture at 80° C.

13. The method of claim 11, wherein the heating step is performed for twenty-four and forty-eight hours.

14. The method of claim 11, wherein a desert rose form of LiCoO₂ is created.

15. The method of claim 11, wherein the mixture of CsOH.H₂O, KOH, LiOH used as the flux is a eutectic mixture.
